(19) United States
(12) Patent Application Publication
(10) Pub. No.: US 2026/0209009 A1
(43) Pub. Date: Jul. 23, 2026

(54) PATH PLANNING METHOD AND APPARATUS, AND CRANE

(71) Applicant: XCMG CONSTRUCTION MACHINERY CO., LTD. BUILDING MACHINERY CO., Xuzhou, Jiangsu (CN)

(72) Inventors: Dechang XIA, Xuzhou (CN); Jinjun MENG, Xuzhou (CN); Xiangchao LIU, Xuzhou (CN); Jihai YANG, Xuzhou (CN); Wenlong HUI, Xuzhou, (CN)

(21) Appl. No.: 19/142,522

(22) PCT Filed: Dec. 12, 2023
(86) PCT No.: PCT/CN2023/138149

§ 371 Date: Jun. 23, 2025

(30) Foreign Application Priority Data
Jan. 6, 2023 (CN) 202310016832.1

(51) Int. Cl. B66C 15/04; B66C 13/48; G01S 7/41; G01S 13/08; G01S 13/89; G01S 13/931

(52) U.S. Cl. CPC B66C 15/045; B66C 13/48; G01S 7/417; G01S 13/08; G01S 13/89; G01S 13/931

(57) ABSTRACT

The present disclosure relates to a path planning method, apparatus and a crane, and relates to the technical field of construction machinery. The path planning method includes: obtaining an environmental image during a driving process of a vehicle; processing the environmental image by using a trained target detection model to identify an obstacle in an environment where the vehicle is located; in a case where an environmental point cloud corresponding to the environmental image is obtained and a system performance index meets a preset condition, determining a spatial position of the obstacle by using the environmental point cloud corresponding to the environmental image; and adjusting an initial driving path of the vehicle according to a current position of the vehicle, the spatial position of the obstacle, and a target position of the vehicle.

### CROSS-REFERENCE TO RELATED APPLICATIONS

The present disclosure is based on and claims the priority to the Chinese application No. 202310016832.1 filed on Jan. 6, 2023, the disclosure of which is incorporated herein by reference in its entirety.

### TECHNICAL FIELD

The present disclosure relates to the technical field of construction machinery, and in particular to a path planning method and apparatus and a crane.

### BACKGROUND

A crawler crane, as a type of crane travelling by using a track, has a strong hoisting capability, playing an important role in infrastructure construction, wind power construction, nuclear power construction, petrochemical construction, and other aspects.

Before the crawler crane carries out a hoisting operation, the crawler crane needs to be driven to a specified hoisting site. At present, automatic driving technology has not yet been effectively applied to large construction machinery. Autonomous driving of the crawler crane faces a challenge of path planning.

In the related art, the crawler crane is generally operated and controlled by a driver in a cab, or remotely controlled outside the cab.

### SUMMARY

According to a first aspect of the present disclosure, there is provided a path planning method, comprising: obtaining an environmental image in during driving process of a vehicle; processing the environmental image by using a trained target detection model to identify an obstacle in an environment where the vehicle is located; in a case where an environmental point cloud corresponding to the environmental image is obtained and a system performance index meets a preset condition, determining a spatial position of the obstacle by using the environmental point cloud corresponding to the environmental image; and adjusting an initial driving path of the vehicle according to a current position of the vehicle, the spatial position of the obstacle, and a target position of the vehicle.

In some embodiments, the method further comprises: in a case where the environmental point cloud corresponding to the environmental image is not obtained, or the system performance index does not meet the preset condition, determining the spatial position of the obstacle according to a transformation between a pixel coordinate and a spatial coordinate.

In some embodiments, the transformation between the pixel coordinate and the spatial coordinate is a transformation between the pixel coordinate and a spatial coordinate in a vehicle coordinate system, and the determining a spatial position of the obstacle according to a transformation between a pixel coordinate and a spatial coordinate comprises: setting a plurality of pixel grids on the environmental image; searching the plurality of pixel grids for a pixel grid where the obstacle is located; determining a pixel coordinate of the obstacle according to the pixel grid where the obstacle is located; and determining a spatial position of the obstacle in the vehicle coordinate system according to the pixel coordinate of the obstacle and the transformation between the pixel coordinate and the spatial coordinate in the vehicle coordinate system.

In some embodiments, the setting a plurality of grids on the environmental image comprises: processing the environmental image by using a trained road segmentation model to identify a drivable road area for the vehicle; and setting the plurality of grids on the drivable road area on the environmental image.

In some embodiments, the determining a spatial position of the obstacle by using the environmental point cloud corresponding to the environmental image comprises: determining, from the environmental point cloud, a point cloud point matched with an image coordinate of the obstacle; and determining a spatial position of the obstacle in a vehicle coordinate system according to the point cloud point matched with the image coordinate of the obstacle and a coordinate transformation between a radar coordinate system where the point cloud point is located and the vehicle coordinate system.

In some embodiments, the adjusting an initial driving path of the vehicle according to a current position of the vehicle, the spatial position of the obstacle, and a target position of the vehicle comprises: determining whether a distance from the vehicle to the obstacle is less than or equal to a safe distance; and in a case where the distance from the vehicle to the obstacle is less than or equal to the safe distance, re-planning a driving path of the vehicle according to the current position of the vehicle, the spatial position of the obstacle, and the target position of the vehicle, and adjusting the initial driving path of the vehicle according to the re-planned driving path.

In some embodiments, the method further comprises: in a case where the distance from the vehicle to the obstacle is less than or equal to the safe distance, instructing the vehicle to stop; and after the adjusted driving path of the vehicle is obtained, instructing the vehicle to resume driving and continue driving according to the adjusted driving path of the vehicle.

In some embodiments, the safe distance is in positive correlation with a size of the vehicle.

In some embodiments, the method further comprises: in a case where there is no obstacle in the environment where the vehicle is located, or the distance between the vehicle and the obstacle is greater than the safe distance, instructing the vehicle to continue driving according to the initial driving path.

In some embodiments, the method further comprises: before the obtaining an environmental image during a driving process of a vehicle, planning the initial driving path of the vehicle by using a preset path planning algorithm, according to a pre-constructed global environmental map, an initial position of the vehicle, and the target position of the vehicle; and/or, in a case where there is the obstacle in the environment where the vehicle is located, updating the pre-constructed global environmental map according to information of the obstacle.

According to a second aspect of the present disclosure, there is provided a path planning apparatus, comprising: an obtaining module configured to obtain an environmental image during a driving process of a vehicle; an identification module configured to process the environmental image by using a trained target detection model to identify an obstacle in an environment where the vehicle is located; a determination module configured to, in a case where an environmental point cloud corresponding to the environmental image is obtained and a system performance index meets a preset condition, determine a spatial position of the obstacle by using the environmental point cloud corresponding to the environmental image; and an adjustment module configured to adjust an initial driving path of the vehicle according to a current position of the vehicle, the spatial position of the obstacle, and a target position of the vehicle.

According to a third aspect of the present disclosure, there is provided a path planning apparatus, comprising: a memory; and a processor coupled to the memory, the processor being configured to perform the path planning method as described above based on instructions stored in the memory.

According to a fourth aspect of the present disclosure, there is provided a crane, comprising: the path planning apparatus as described above.

According to a fifth aspect of the present disclosure, there is provided a computer-readable storage medium having thereon stored computer program instructions which, when executed by a processor, implement the path planning method as described above.

According to a sixth aspect of the present disclosure, there is provided a computer program, comprising: instructions which, when executed by a processor, cause the processor to perform the path planning method as described above.

### BRIEF DESCRIPTION OF THE DRAWINGS

The accompanying drawings, which constitute a part of the specification, illustrate embodiments of the present disclosure and together with the description, serve to explain the principles of the present disclosure.

The present disclosure may be more clearly understood according to the following detailed description with reference to the accompanying drawings, in which:

FIG. 1 is a schematic flow diagram illustrating a path planning method according to some embodiments of the present disclosure;

FIG. 2 is a schematic flow diagram illustrating a path planning method according to other embodiments of the present disclosure;

FIG. 3 is a schematic flow diagram illustrating adjustment of a driving path of a vehicle according to some embodiments of the present disclosure;

FIG. 4 is a schematic flow diagram illustrating adjustment of a driving path of a vehicle according to further embodiments of the present disclosure;

FIG. 5 is a block diagram illustrating a path planning apparatus according to some embodiments of the present disclosure;

FIG. 6 is a block diagram illustrating a crane according to some embodiments of the present disclosure;

FIG. 7 is a schematic structural diagram illustrating a crane according to some embodiments of the present disclosure;

FIG. 8 is a schematic mounting diagram illustrating a camera and radar according to some embodiments of the present disclosure;

FIG. 9 is a block diagram illustrating a path planning apparatus according to other embodiments of the present disclosure;

FIG. 10 is a block diagram illustrating a computer system for implementing some embodiments of the present disclosure.

### DETAILED DESCRIPTION

Various exemplary embodiments of the present disclosure will now be described in detail with reference to the accompanying drawings. It should be noted that: the relative arrangement of components and steps, numerical expressions and numerical values set forth in these embodiments do not limit the scope of the present disclosure unless specifically stated otherwise.

Meanwhile, it should be understood that the sizes of the parts shown in the drawings are not drawn to actual scale for the convenience of description.

The following description of at least one exemplary embodiment is merely illustrative in nature and is in no way intended to limit this disclosure and its application or use.

Techniques, methods, and devices known to one of ordinary skill in the related art may not be discussed in detail but are intended to be part of the specification where appropriate.

In all examples shown and discussed herein, any specific value should be construed as exemplary only and not as limiting. Thus, other examples of the exemplary embodiments may have different values.

It should be noted that: similar reference numbers and letters refer to similar items in the following drawings, and thus once a certain item is defined in one drawing, it need not be discussed further in subsequent drawings.

Inventors of the present disclosure found that, operation and control of a crawler crane by a driver in the related art has the following disadvantages: 1) planning of a driving path of the crane heavily depends on professional skills and operation experience of the driver, making it difficult to ensure a path planning effect, and it has high labor cost and low operational efficiency; 2) it has a high requirement on an operation environment, and cannot adapt to a complex and variable operation environment; and 3) for a hazardous work environment such as a complex operation environment and a bad weather environment, the traditional vehicle operation and control cannot ensure personal safety of the driver.

In view of this, the present disclosure provides a path planning method, capable of automatically planning a driving path of a crane, improving the flexibility and planning effect of the planning of the driving path of the crane.

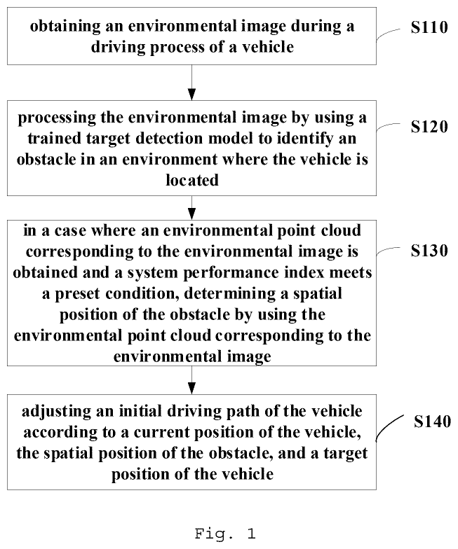

FIG. 1 is a schematic flow diagram illustrating a path planning method according to some embodiments of the present disclosure. As shown in FIG. 1, the path planning method according to the embodiment of the present disclosure comprises step S110, obtaining an environmental image during a driving process of a vehicle.

In some embodiments, the path planning method is performed by a path planning apparatus.

In some embodiments, the environmental image in the driving process of the vehicle is obtained periodically. For example, after the environmental image in the driving process of the vehicle, which is acquired by a monocular camera, is stored in a storage module, the environmental image in the driving process of the vehicle is periodically obtained from the storage module.

In some embodiments, the vehicle (e.g., a crane) is thereon mounted with a vision sensor, radar, etc. For example, the vision sensor is the monocular camera and the radar is a laser radar. In these embodiments, the environmental image in the driving process of the vehicle is acquired by the monocular camera, and point cloud data in the driving process of the vehicle is acquired by the laser radar.

The path planning method comprises step S120, processing the environmental image by using a trained target detection model to identify an obstacle in an environment where the vehicle is located.

In some embodiments, for the target detection model, a neural network model such as a YOLO model is employed. In these embodiments, the environmental image in the driving process of the vehicle that is obtained in the step S110 is input into a trained target detection model, to detect whether there is an obstacle in the environment where the vehicle is located, and in a case where the obstacle is detected, a type of the obstacle and an image coordinate of the obstacle are determined.

The path planning method comprises step S130, in a case where an environmental point cloud corresponding to the environmental image is obtained and a system performance index meets a preset condition, determining a spatial position of the obstacle by using the environmental point cloud corresponding to the environmental image.

In some embodiments, the determining a spatial position of the obstacle by using the environmental point cloud corresponding to the environmental image comprises: determining, from the environmental point cloud corresponding to the environmental image, a point cloud point matched with the image coordinate of the obstacle; and determining a spatial position of the obstacle in a vehicle coordinate system according to the point cloud point matched with the image coordinate of the obstacle and a coordinate transformation between a radar coordinate system where the point cloud point is located and the vehicle coordinate system.

For example, after the image coordinate of the obstacle is determined based on the environmental image, a coordinate of the point cloud point matched with the image coordinate of the obstacle is determined by using a coordinate transformation between an image coordinate system and the radar coordinate system where the point cloud point is located and the image coordinate of the obstacle; and the spatial position of the obstacle in the vehicle coordinate system is determined by using the coordinate of the point cloud point matched with the image coordinate of the obstacle and the coordinate transformation between the radar coordinate system where the point cloud point is located and the vehicle coordinate system.

In some embodiments, the environmental point cloud corresponding to the environmental image is an environmental point cloud with a timestamp that is consistent with a timestamp of the environmental image.

For example, at a time t1, the system acquires an environmental image in the driving progress of the vehicle and an environmental point cloud in the driving progress of the vehicle, then it obtains the environmental point cloud corresponding to the environmental image when processing the environmental image at the time t1.

For example, at a time t2, the system acquires an environmental image in the driving progress of the vehicle and acquires no environmental point cloud in the driving progress of the vehicle, then it obtains no environmental point cloud corresponding to the environmental image when processing the environmental image at the time t2.

In some embodiments, the system performance index includes a CPU utilization ratio and a memory utilization ratio, and the system performance index meeting a preset condition comprises: the CPU utilization ratio being less than a first preset threshold, and the memory utilization ratio being less than a second preset threshold. In addition, the system performance index may also be one or more other indexes by which the system performance can be measured.

In the embodiment of the present disclosure, it is determined whether the environmental point cloud corresponding to the environmental image is obtained and it is determined whether the system performance index meets the preset condition, and in a case where the environmental point cloud is obtained and the system performance index meets the preset condition, the obstacle is positioned by using the environmental point cloud, whereby the accuracy of the positioning of the obstacle can be improved while real-time processing is considered, thereby helping to optimize the path planning effect while the real-time path planning is ensured.

The path planning method comprises step S140, adjusting an initial driving path of the vehicle according to a current position of the vehicle, the spatial position of the obstacle, and a target position of the vehicle.

In some embodiments, a path of the vehicle is re-planned by using a preset path planning algorithm, according to the current position of the vehicle, the spatial position of the obstacle, and the target position of the vehicle, and the initial driving path is adjusted according to the re-planned driving path of the vehicle.

For example, the current position of the vehicle is determined according to a positioning module mounted on the vehicle. The positioning module includes at least one of a global positioning system (GPS), an inertial measurement unit (IMU) or other positioning sensors.

For example, for the path planning algorithm, an A* algorithm is employed. The A* algorithm is a direct search method for solving a shortest path in a static road network, and is also an effective algorithm for solving many search problems. The closer an estimated value of a distance in the algorithm is to an actual value of the distance, the faster the final search speed is.

For example, the path adjustment operation is specifically to replace the initial driving path in the storage module with the re-planned driving path of the vehicle.

In the embodiment of the present disclosure, the driving path of the crane can be automatically planned by the above steps. Compared with the related art, the flexibility and planning effect of the planning of the driving path of the crane can be improved.

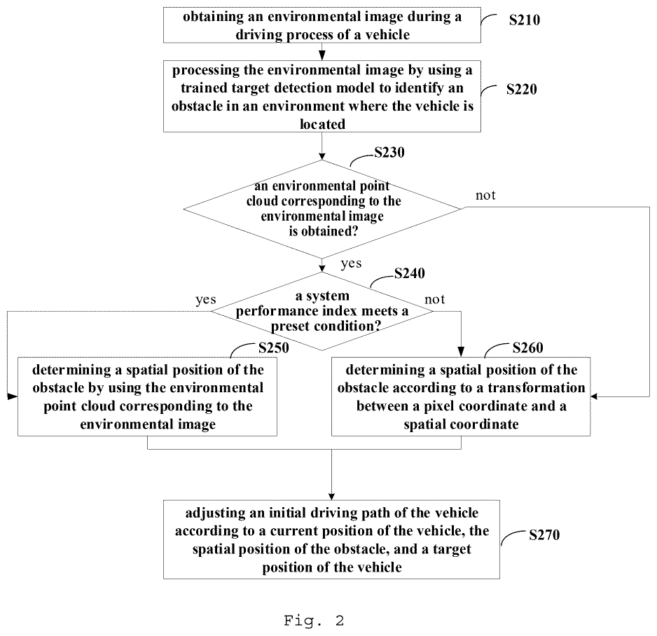

FIG. 2 is a schematic flow diagram illustrating a path planning method according to other embodiments of the present disclosure. As shown in FIG. 2, the path planning method according to the embodiment of the present disclosure comprises step S210, obtaining an environmental image during a driving process of a vehicle.

In some embodiments, the environmental image in the driving process of the vehicle is obtained periodically. For example, after the environmental image in the driving process of the vehicle, which is acquired by a monocular camera, is stored in a storage module, the environmental image in the driving process of the vehicle is periodically obtained from the storage module.

In some embodiments, the vehicle (e.g., a crane) is thereon mounted with a vision sensor, radar, etc. For example, the vision sensor is the monocular camera and the radar is a laser radar. In these embodiments, the environmental image in the driving process of the vehicle is acquired by the monocular camera, and point cloud data in the driving process of the vehicle is acquired by the laser radar.

In some embodiments, before the step S210, the method further comprises planning an initial driving path of the vehicle by using a preset path planning algorithm, according to a pre-constructed global environmental map, an initial position of the vehicle, and a target position of the vehicle.

In some embodiments, the global environmental map is constructed by: acquiring point cloud data by using a plurality of laser radars; transforming, by using a coordinate system transformation matrix, the point cloud data acquired by the plurality of laser radars into a same coordinate system, for example, a coordinate system of a main radar; according to an acquisition timestamp and a feature matching relation between the point cloud data, splicing and fusing the point cloud data which is transformed into the same coordinate system and corresponds to a same acquisition timestamp, to obtain fused point cloud data, wherein the fused point cloud data includes a plurality of sets of fused point cloud data corresponding to different vehicle pose data; and according to the fused point cloud data and the pose data of the vehicle, performing external environment mapping in a driving area of the vehicle to obtain the global environmental map.

For example, three laser radars are arranged in front of a cab of a crawler crane, as detection radars for the front of the crawler crane; and one laser radar is arranged in front-left of the cab of the crawler crane and one laser radar is arranged in front-right of the cab of the crawler crane, respectively, as gap filler radars for a ground where the crawler crane drives and an obstacle on the ground. The three detection radars are mainly used for positioning and measuring of targets ahead such as obstacle, hoisted object, hook, there should be overlapping parts between fields of view of the three detection radars, and by mutual cooperation of the three detection radars, no blind spot ahead and complete scanning of an area in front of the vehicle can be guaranteed as far as possible. Exemplarily, let a field of view of each detection radar be 70.4°×77.2°. The two gap filler radars are mainly used for scanning the ground and the obstacle on the ground. After point cloud data is acquired by using the three detection radars and the two gap filler radars, the acquired point cloud data is spliced and fused according to an acquisition timestamp and a feature matching relation, and then based on the fused point cloud data and pose data of the vehicle, external environment mapping is performed on a driving area of the vehicle.

In some embodiments, in order to reduce time consumption of the algorithm, before the plurality of point cloud data is spliced and fused, down-sampling is performed on the point cloud data acquired by the laser radars.

In some embodiments, the pose data of the vehicle is acquired by using a real-time kinematic (RTK) measurement module. After the plurality of sets of fused point cloud data corresponding to the different vehicle pose data are obtained, the plurality of sets of fused point cloud data are transformed into a vehicle coordinate system according to a coordinate transformation matrix between a radar coordinate system and the vehicle coordinate system, to obtain a plurality of sets of point cloud data in the vehicle coordinate system under different vehicle poses; and according to the vehicle pose data, the plurality of sets of point cloud data in the vehicle coordinate systems under the different vehicle poses are transformed into a vehicle coordinate system under a same vehicle pose, for example, a vehicle coordinate system under an initial vehicle pose, and then based on the point cloud data in the vehicle coordinate system under the initial vehicle pose, the global environmental map is constructed.

For example, after the point cloud data in the vehicle coordinate system under the initial vehicle pose is obtained, the global environmental map is constructed based on a road segmentation model. Exemplarily, for the road segmentation model, a DeepLabV3+ model may be employed. The DeepLabV3+ model is a graph segmentation algorithm in combination with deep convolutional neural networks (DCNNs for short) and probabilistic graphical models (DenseCRFs), in which a lightweight neural network MobileNetV2 is introduced to extract road features, multi-scale road information features are captured by using an atrous spatial pyramid pooling operation, low-level and high-level features are fused, and road edges are restored finely, to complete segmentation of a road drivable area.

For example, the constructed global environmental map is an octree map. An octree is a data structure for describing a three-dimensional space, each node of which represents a volume element of a cube and has eight child nodes.

The path planning method comprises step S220, processing the environmental image by using a trained target detection model to identify an obstacle in an environment where the vehicle is located.

In some embodiments, for the target detection model, a neural network model such as a YOLO model is employed. In these embodiments, the environmental image in the driving process of the vehicle that is obtained in the step S210 is input into a trained target detection model, to detect whether there is the obstacle in the environment where the vehicle is located, and in a case where the obstacle is detected, a type of the obstacle and an image coordinate of the obstacle are determined.

The path planning method comprises step S230, determining whether an environmental point cloud corresponding to the environmental image is obtained.

In some embodiments, whether an environmental point cloud corresponding to the environmental image is obtained is determined by: determining whether an environmental point cloud with a timestamp consistent with a timestamp of the environmental image is obtained; and if so, determining that the environmental point cloud corresponding to the environmental image is obtained, otherwise, determining that the environmental point cloud corresponding to the environmental image is not obtained.

In a case where the environmental point cloud corresponding to the environmental image is obtained, step S240 is performed; and in a case where the environmental point cloud corresponding to the environmental image is not obtained, step S260 is performed.

The path planning method comprises step S240, determining whether a system performance index meets a preset condition.

In some embodiments, the system performance index includes a central processing unit (CPU for short) utilization ratio, and whether a system performance index meets a preset condition is determined by: determining whether the CPU utilization ratio of the system is less than a first preset threshold; if SO, determining that the system performance index meets the preset condition; and if not, determining that the system performance index does not meet the preset condition.

In some embodiments, the system performance index includes a CPU utilization ratio and a memory utilization ratio, and whether a system performance index meets a preset condition is determined by: determining whether the CPU utilization ratio is less than a first preset threshold and whether the memory utilization ratio is less than a second preset threshold; if so, determining that the system performance index meets the preset condition; and if not, determining that the system performance index does not meet the preset condition. In addition, the system performance index may be one or more other indexes by which the system performance can be measured.

Under the condition of determining that the system performance index meets the preset condition, step S250 is performed; and under the condition of determining that the system performance index does not meet the preset condition, step S260 is performed.

The path planning method comprises step S250, determining a spatial position of the obstacle by using the environmental point cloud corresponding to the environmental image.

In some embodiments, the step S250 comprises: determining, from the environmental point cloud, a point cloud point matched with an image coordinate of the obstacle; and determining a spatial position of the obstacle in the vehicle coordinate system, according to the point cloud point matched with the image coordinate of the obstacle and a coordinate transformation between a radar coordinate system where the point cloud point is located and the vehicle coordinate system.

The path planning method comprises step S260, determining a spatial position of the obstacle according to a transformation between a pixel coordinate and a spatial coordinate.

In some embodiments, the step S260 comprises: setting a plurality of pixel grids on the environmental image; searching the plurality of pixel grids for a pixel grid where the obstacle is located; determining a pixel coordinate of the obstacle according to the pixel grid where the obstacle is located; and determining the spatial position of the obstacle in the vehicle coordinate system according to the pixel coordinate of the obstacle and a transformation between the pixel coordinate and a spatial coordinate in the vehicle coordinate system.

In some embodiments, the setting a plurality of grids on the environmental image is performed by: processing the environmental image by using a trained road segmentation model to identify a drivable road area for the vehicle; and setting the plurality of grids on the drivable road area on the environmental image. By setting the grids only on the drivable road area on the environmental image, instead of in other areas on the environmental image, the amount of grid search can be reduced and the amount of other unnecessary calculation can be reduced, thereby helping to improve the real-time of the path planning.

In the embodiment of the present disclosure, by determining whether the environmental point cloud corresponding to the environmental image is obtained and determining whether the system performance index meets the preset condition, and in a case where both determinations are yes, positioning the obstacle accurately by using the environmental point cloud, and in a case where one of the determinations is not yes, positioning the obstacle roughly by using the transformation between the pixel coordinate and the spatial coordinate, an obstacle positioning mode can be adaptively adopted according to the data acquisition and system performance situations, and certain accuracy of the obstacle positioning can be ensured while the real-time of the processing is considered, thereby optimizing the path planning effect while the real-time of the path planning is ensured. In addition, compared with only using the environmental point cloud for the accurate positioning of the obstacle or only using the transformation between the pixel coordinate and the spatial coordinate for the rough positioning of the obstacle, the embodiment reduces the situations of the poor path planning effect and even inability to perform path planning due to inaccurate obstacle positioning and even inability to perform obstacle positioning, improving the reliability and success ratio of the path planning, and further improving the safety of autonomous driving of the crane.

After the step S250 or step S260, step S270 is performed.

The path planning method comprises step S270, adjusting an initial driving path of the vehicle according to a current position of the vehicle, the spatial position of the obstacle, and a target position of the vehicle.

In some embodiments, a path of the vehicle is re-planned by using a preset path planning algorithm, according to the current position of the vehicle, the spatial position of the obstacle, and the target position of the vehicle, and the initial driving path is adjusted according to the re-planned driving path of the vehicle.

For example, the current position of the vehicle is determined according to a positioning module mounted on the vehicle. The positioning module includes at least one of a global positioning system (GPS), an inertial measurement unit (IMU) or other positioning sensors.

For example, for the path planning algorithm, an A* algorithm is employed. The A* algorithm is a direct search method for solving a shortest path in a static road network, and is also an effective algorithm for solving many search problems. The closer an estimated value of a distance in the algorithm is to an actual value of the distance, the faster the final search speed is.

For example, the path adjustment operation is specifically to replace the initial driving path in the storage module with the re-planned driving path of the vehicle.

In the embodiment of the present disclosure, the driving path of the crane can be automatically planned by the above steps. Compared with the related art, the flexibility and planning effect of the planning of the driving path of the crane can be improved.

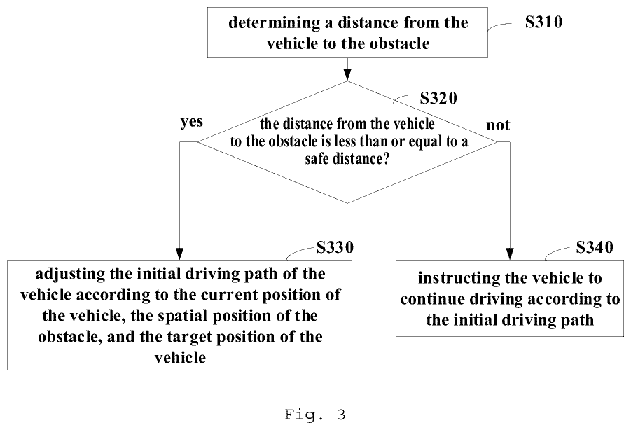

FIG. 3 is a flow diagram illustrating adjustment of a driving path of a vehicle according to some embodiments of the present disclosure. As shown in FIG. 3, the process of adjusting the driving path of the vehicle in the embodiment of the present disclosure comprises step S310, determining a distance from the vehicle to the obstacle.

In some embodiments, the step S310 comprises determining the distance from the vehicle to the obstacle according to the spatial coordinate of the obstacle in the vehicle coordinate system.

The process of adjusting the driving path of the vehicle comprises step S320, determining whether the distance from the vehicle to the obstacle is less than or equal to a safe distance.

In some embodiments, the safe distance is determined according to a size of the vehicle, wherein the safe distance is in positive correlation with the size of the vehicle. For example, a maximum in a length and width of the vehicle is taken as the safety distance.

embodiments, the safe distance is determined according to the size of the vehicle and detection information of the obstacle. For example, different safe distance calculation modes are preset for different obstacle types, and after a safe distance calculation mode corresponding to an obstacle type is determined, the safe distance is determined by using the calculation mode and the size information of the vehicle.

In a case where the distance from the vehicle to the obstacle is less than or equal to the safe distance, step S330 is performed; and in a case where the distance from the vehicle to the obstacle is greater than the safety distance, step S340 is performed.

The process of adjusting the driving path of the vehicle comprises step S330, adjusting the initial driving path of the vehicle according to the current position of the vehicle, the spatial position of the obstacle, and the target position of the vehicle.

In some embodiments, a driving path of the vehicle is re-planned by using a preset path planning algorithm, according to the current position of the vehicle, the spatial position of the obstacle, and the target position of the vehicle, and the initial driving path of the vehicle is replaced with the re-planned driving path. The path planning algorithm used in the re-planning may be the same as or different from that used in initially performing path planning.

For example, one path planning algorithm is preset, and when the step S330 is performed, a path is re-planned by using the same path planning algorithm as that used in initially performing path planning.

For example, a plurality of path planning algorithms are preset, and when the step S330 is performed, a path planning algorithm corresponding to a current system performance index is selected from the plurality of path planning algorithms, and a driving path of the vehicle is re-planned by using the path planning algorithm corresponding to the current system performance index. With the above processing, a path planning algorithm with a large amount of calculation and a good planning effect can be selected when the current system performance is good, and a path planning algorithm with a small amount of calculation and good real-time is selected when the current system performance is poor, thereby considering the real-time of the path planning and the path planning effect.

The process of adjusting the driving path of the vehicle comprises step S340, instructing the vehicle to continue driving according to the initial driving path.

In a case where the distance from the vehicle to the obstacle is greater than the safe distance, the vehicle is instructed to continue driving according to the initial driving path. In addition, under the condition of detecting, based on the trained target detection model, that there is no obstacle in the environment where the vehicle is located, the vehicle is also instructed to continue driving according to the initial driving path.

In the embodiment of the present disclosure, by setting the safe distance, and re-planning the driving path under a condition that the distance from the vehicle to the obstacle is less than or equal to the safe distance, and continuing driving according to the initial driving path under a condition that the distance from the vehicle to the obstacle is greater than the safe distance, a frequency of the path planning can be reduced as far as possible while the driving safety of the vehicle is guaranteed, optimizing the performance of the autonomous driving service of the crane.

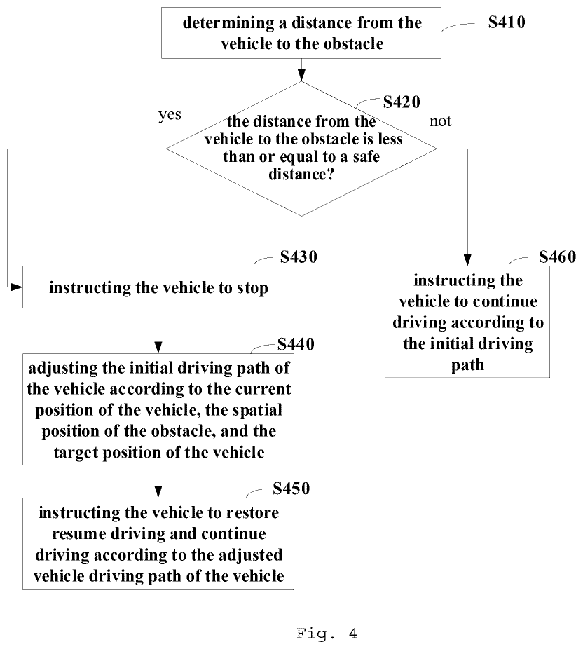

FIG. 4 is a schematic flow diagram illustrating adjustment of a driving path of a vehicle according to further embodiments of the present disclosure. FIG. 4 is an exemplary illustration of the step S140 in the flow shown in FIG. 1 and the step S270 in the flow shown in FIG. 2. As shown in FIG. 4, the process of adjusting the driving path of the vehicle in the embodiment of the present disclosure comprises step S410, determining a distance from the vehicle to the obstacle.

In some embodiments, the step S410 comprises determining the distance from the vehicle to the obstacle according to the spatial coordinate of the obstacle in the vehicle coordinate system. For example, the spatial coordinate of the obstacle in the vehicle coordinate system and the coordinate of the vehicle are substituted into an Euclidean distance calculation formula between two points, to determine the distance from the vehicle to the obstacle.

The process of adjusting the driving path of the vehicle comprises step S420, determining whether the distance from the vehicle to the obstacle is less than or equal to a safe distance.

In some embodiments, the safe distance is determined according to a size of the vehicle, wherein the safe distance is in positive correlation with the size of the vehicle. For example, a maximum in a length and width of the vehicle is taken as the safety distance.

In a case where the distance from the vehicle to the obstacle is less than or equal to the safe distance, steps S430, S440, and S450 are performed; and in a case where the distance from the vehicle to the obstacle is greater than the safe distance, step S460 is performed.

The process of adjusting the driving path of the vehicle comprises step S430, instructing the vehicle to stop.

In a case where the distance from the vehicle to the obstacle is less than or equal to the safe distance, the vehicle (e.g., a crawler crane) is instructed to stop, which can avoid a danger of collision of the vehicle with the obstacle due to continuing driving of the vehicle according to the initially planned path, improving safety of autonomous driving of the vehicle.

In some embodiments, the process of adjusting the driving path of the vehicle further comprises, in a case where there is the obstacle in the environment where the vehicle is located, updating the pre-constructed global environmental map according to information of the obstacle.

For example, after it is determined that the distance from the vehicle to the obstacle is less than the safe distance, the pre-constructed global environmental map is updated according to the information of the obstacle. In the driving process of the vehicle, the pre-constructed global environmental map is updated based on the acquired obstacle information, helping to improve the accuracy of the global environmental map, avoiding as far as possible a situation where a certain obstacle exists in a real environment but is not included in the global environmental map, and then helping to improve the reliability and accuracy of subsequent path planning based on the global environmental map.

The process of adjusting the driving path of the vehicle comprises step S440, adjusting the initial driving path of the vehicle according to the current position of the vehicle, the spatial position of the obstacle, and the target position of the vehicle.

In some embodiments, a driving path of the vehicle is re-planned by using a preset path planning algorithm, according to the current position of the vehicle, the spatial position of the obstacle, and the target position of the vehicle, and the initial driving path of the vehicle is replaced with the re-planned driving path.

The process of adjusting the driving path of the vehicle comprises step S450, instructing the vehicle to resume driving and continue driving according to the adjusted driving path of the vehicle.

In some embodiments, in a case where the re-planning of the driving path of the vehicle is successful, step S450 is performed; and in a case where the re-planning of the driving path of the vehicle is failed, alarm information is generated and sent to a management and maintenance terminal for the vehicle. For example, in a scene of unmanned driving of the crane, alarm information is sent to a terminal device of a management and maintenance staff that corresponds to the vehicle, so that the management and maintenance staff intervenes in time.

The process of adjusting the driving path of the vehicle comprises step S460, instructing the vehicle to continue driving according to the initial driving path.

In a case where the distance from the vehicle to the obstacle is greater than the safe distance, the vehicle is instructed to continue driving according to the initial driving path. In addition, under the condition of detecting, based on the trained target detection model, that there is no obstacle in the environment where the vehicle is located, the vehicle is also instructed to continue driving according to the initial driving path.

In the embodiment of the present disclosure, by setting the safe distance, and stopping the vehicle and re-planning the driving path under the condition that the distance from the vehicle to the obstacle is less than or equal to the safe distance, and instructing the vehicle to continue driving according to the initial driving path under the condition that the distance from the vehicle to the obstacle is greater than the safe distance, a frequency of the path planning can be reduced as far as possible while further ensuring the driving safety of the vehicle, optimizing the performance of the autonomous driving service of the crane.

FIG. 5 is a block diagram illustrating a path planning apparatus according to some embodiments of the present disclosure. As shown in FIG. 5, the path planning apparatus 500 according to the embodiment of the present disclosure comprises an obtaining module 510, an identification module 520, a determination module 530, and an adjustment module 540.

The obtaining module 510 is configured to obtain an environmental image during a driving process of a vehicle.

In some embodiments, the obtaining module 510 periodically obtains the environmental image in the driving process of the vehicle. For example, after the environmental image in the driving process of the vehicle, which is acquired by a monocular camera, is stored in a storage module, the obtaining module 510 periodically obtains the environmental image in the driving process of the vehicle from the storage module.

The identification module 520 is configured to process the environmental image by using a trained target detection model, to identify an obstacle in an environment where the vehicle is located.

In some embodiments, for the target detection model, a neural network model such as a YOLO model or other target detection model for processing image data is employed. In these embodiments, the identification module 520 detects, by using the trained target detection model, whether there is the obstacle in the environment where the vehicle is located, and under the condition of detecting the obstacle, determines a type of the obstacle and an image coordinate of the obstacle.

The determination module 530 is configured to, in a case where an environmental point cloud corresponding to the environmental image is obtained and a system performance index meets a preset condition, determine a spatial position of the obstacle by using the environmental point cloud corresponding to the environmental image.

In some embodiments, the determining, by the determination module 530, a spatial position of the obstacle by using the environmental point cloud corresponding to the environmental image, comprises: determining, by the determination module 530, from the environmental point cloud corresponding to the environmental image, a point cloud point matched with the image coordinate of the obstacle; and determining, by the determination module 530, a spatial position of the obstacle in a vehicle coordinate system, according to the point cloud point matched with the image coordinate of the obstacle and a coordinate transformation between a radar coordinate system where the point cloud point is located and the vehicle coordinate system.

For example, after determining the image coordinate of the obstacle based on the environmental image, the determination module 530 determines a coordinate of the point cloud point matched with the image coordinate of the obstacle by using a coordinate transformation between an image coordinate system and the radar coordinate system where the point cloud point is located, and the image coordinate of the obstacle; and the determination module 530 determines the spatial position of the obstacle in the vehicle coordinate system by using the coordinate of the point cloud point matched with the image coordinate of the obstacle and the coordinate transformation between the radar coordinate system where the point cloud point is located and the vehicle coordinate system.

In the embodiment of the present disclosure, by determining whether the environmental point cloud corresponding to the environmental image is obtained and determining whether the system performance index meets the preset condition, and in a case where both determinations are yes, positioning the obstacle by using the environmental point cloud, the accuracy of the obstacle positioning can be improved while the real-time of the processing is considered, thereby helping to optimize the path planning effect while the real-time of the path planning is ensured.

The adjustment module 540 is configured to adjust an initial driving path of the vehicle according to a current position of the vehicle, the spatial position of the obstacle, and a target position of the vehicle.

In some embodiments, a path of the vehicle is re-planned by using a preset path planning algorithm, according to the current position of the vehicle, the spatial position of the obstacle, and the target position of the vehicle, and the initial driving path is adjusted according to the re-planned driving path of the vehicle.

For example, the current position of the vehicle is determined according to a positioning module mounted on the vehicle. The positioning module includes at least one of a global positioning system (GPS), an inertial measurement unit (IMU) or other positioning sensors.

For example, for the path planning algorithm, an A* algorithm is employed. The A* algorithm is a direct search method for solving a shortest path in a static road network, and is also an effective algorithm for solving many search problems. The closer an estimated value of a distance in the algorithm is to an actual value of the distance, the faster the final search speed is.

For example, the path adjustment operation is specifically to replace the initial driving path in the storage module with the re-planned driving path of the vehicle.

In the embodiment of the present disclosure, a driving path of a crane can be automatically planned by the above apparatus. Compared with the related art, the flexibility and planning effect of the planning of the driving path of the crane can be improved.

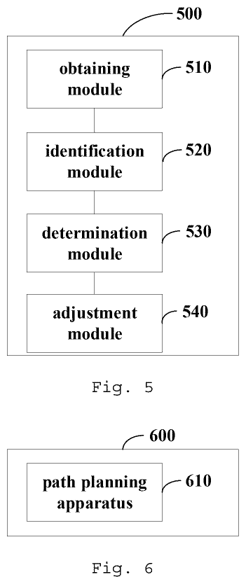

FIG. 6 is a block diagram illustrating a crane according to some embodiments of the present disclosure. As shown in FIG. 6, the crane 600 according to the embodiment of the present disclosure comprises a path planning apparatus 610.

In some embodiments, the crane 600 is a crawler crane. The path planning apparatus 610 in this crane is configured to: obtain an environmental image during a driving process of a vehicle; process the environmental image by using a trained target detection model to identify an obstacle in an environment where the vehicle is located; in a case where an environmental point cloud corresponding to the environmental image is obtained and a system performance index meets a preset condition, determine a spatial position of the obstacle by using the environmental point cloud corresponding to the environmental image; and adjust an initial driving path of the vehicle according to a current position of the vehicle, the spatial position of the obstacle, and a target position of the vehicle.

In the embodiment of the present disclosure, the driving path can be automatically planned by the above crane. Compared with the related art, the flexibility and planning effect of the planning of the driving path of the crane can be improved.

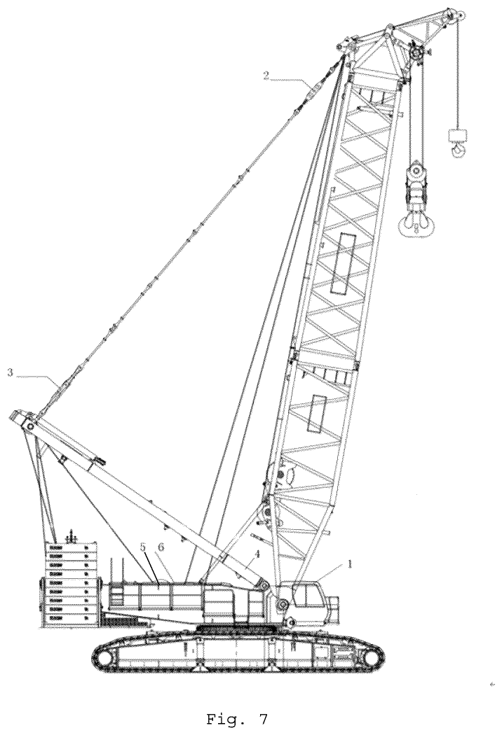

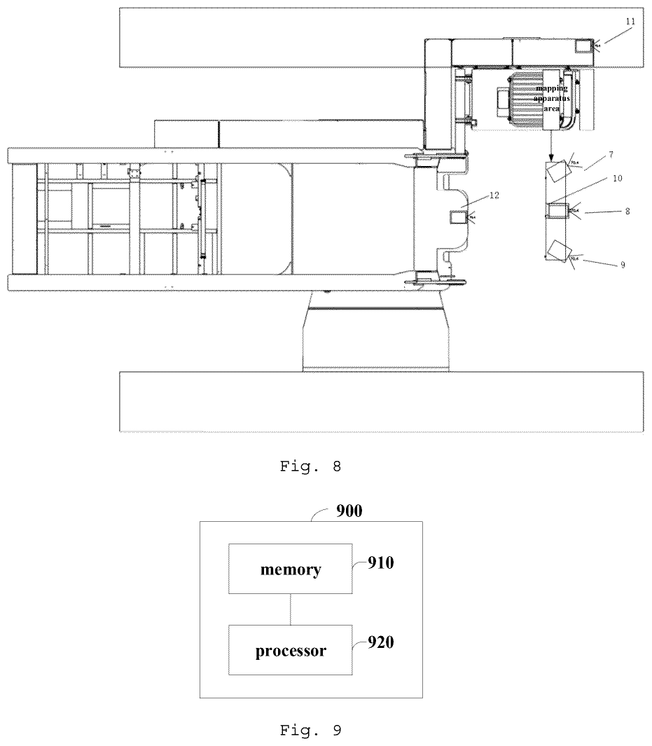

FIG. 7 is a schematic structural diagram illustrating a crane according to some embodiments of the present disclosure. FIG. 8 is a schematic mounting diagram illustrating a camera and radar according to some embodiments of the present disclosure. As shown in FIGS. 7 and 8, the crane according to the embodiment of the present disclosure comprises an environment sensing module 1, a tension sensor 2, a tension sensor 3, a mast jacking cylinder pressure sensor 4, a vehicle-mounted industrial personal computer 5, and a communication conversion module 6.

The environment sensing module 1 is configured to sense an external environment, and specifically includes detection radars 7, 9, and 10, gap filler radars 11 and 12, and a monocular camera 8.

The detection radars 7, 9 and 10 are mounted on a platform above a cab of the crane and are configured to detect a front environment of the crane; the gap filler radars 11 and 12 are mounted in front of the cab, are configured to detect a ground and an obstacle on the ground, and are mainly used for obstacle avoidance in driving; and the monocular camera 8 is mounted above the cab, forming a partial overlap with fields of view of the radars, and is configured to combine point cloud data acquired by the radars, for identification and accurate positioning of the obstacle.

The tension sensor 2 and the tension sensor 3 are configured to measure tension to the crane, and the mast jacking cylinder pressure sensor 4 is configured to measure pressure of the mast jacking cylinder. By providing the above sensors, subsequent control of the components of the crane is facilitated.

The communication conversion module 6 is configured to convert CAN (which is short for Controller Area Network, and is one of field buses most widely used internationally) interface data into TCP interface data, to facilitate subsequent processing of the data by the vehicle-mounted industrial personal computer 5.

The vehicle-mounted industrial personal computer 5 is configured to receive signals of the sensors and send control signals to a boom, a turntable, a chassis and other components. The vehicle-mounted industrial personal computer 5 is further configured to re-plan a driving path according to external environment information sensed by the environment sensing module and control the crane to drive according to the re-planned driving path.

In some embodiments, the vehicle-mounted industrial personal computer 5 comprises a mapping apparatus and a path planning apparatus. The mapping apparatus is configured to construct a global environmental map according to point cloud data scanned by the plurality of vehicle-mounted radars in the moving process of the crawler crane and vehicle pose data. The path planning apparatus is configured to generate the driving path by using a preset path planning algorithm, according to obstacle information identified in the driving process of the vehicle, a current position and target position of the vehicle, and control autonomous movement of the vehicle. In some embodiments, the path planning apparatus adopts the structure shown in FIG. 5.

In the embodiment of the present disclosure, the driving path of the crane can be automatically planned by the above crane. Compared with the related art, the flexibility and planning effect of the planning of the driving path of the crane can be improved.

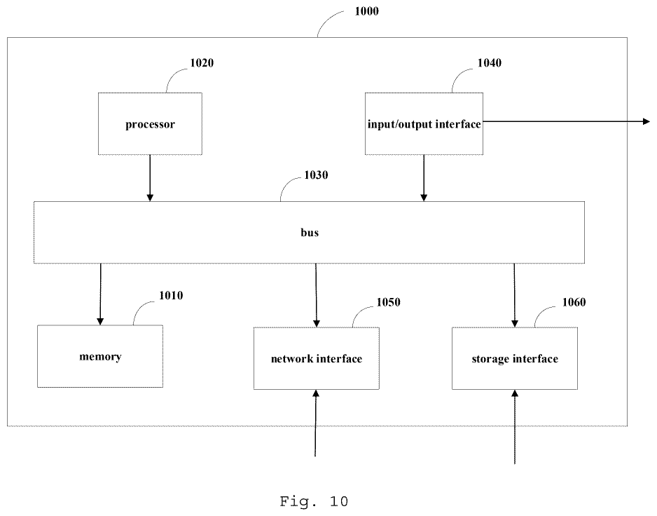

FIG. 9 is a block diagram illustrating a path planning apparatus according to some embodiments of the present disclosure.

As shown in FIG. 9, the path planning apparatus 900 comprises a memory 910; and a processor 920 coupled to the memory 910. The memory 910 is used for storing instructions for the corresponding embodiments for executing the path planning method. The processor 920 is configured to perform the path planning method in any of the embodiments of the present disclosure based on the instructions stored in the memory 910.

FIG. 10 is a block diagram illustrating a computer system for implementing some embodiments of the present disclosure. As shown in FIG. 10, the computer system 1000 may be represented in a form of a general-purpose computing device. The computer system 1000 comprises a memory 1010, a processor 1020, and a bus 1030 for connecting various system components.

The memory 1010 may include, for example, a system memory, non-volatile storage medium, and the like. The system memory has thereon stored, for example, an operating system, an application, a boot loader, and other programs. The system memory may include a volatile storage medium, for example, a random access memory (RAM) and/or cache memory. The non-volatile storage medium has thereon stored, for example, instructions for the corresponding embodiments for executing at least one of the path planning methods. The non-volatile storage medium includes, but is not limited to, a magnetic disk memory, optical memory, flash memory, and the like.

The processor 1020 may be implemented by using a general-purpose processor, a digital signal processor (DSP), an application specific integrated circuit (ASIC), a field programmable gate array (FPGA) or other programmable logic device, a discrete gate or transistor, and other discrete hardware components. Accordingly, each of the modules such as the obtaining module, the identification module, the determination module, and the adjustment module can be implemented by running, by a central processing unit (CPU), instructions in the memory that perform the corresponding steps, or implemented by a dedicated circuit that performs the corresponding steps.

For the bus 1030, any of a variety of bus structures may be used. For example, the bus structure includes, but is not limited to, an industry standard architecture (ISA) bus, a micro channel architecture (MCA) bus, and a peripheral component interconnect (PCI) bus.

The computer system 1000 may also include an input/output interface 1040, network interface 1050, storage interface 1060, and the like. These interfaces 1040, 1050, 1060 and the memory 1010 may be connected with the processor 1020 via the bus 1030. The input/output interface 1040 may provide connection interfaces for input/output devices such as a display, a mouse, and a keyboard. The network interface 1050 provides connection interfaces for various networking devices. The storage interface 1060 provides connection interfaces for external storage devices such as a floppy disk, a USB flash disk, and an SD card.

Various aspects of the present disclosure are described herein with reference to the flow diagrams and/or block diagrams of the method, apparatus, and computer program product according to the embodiments of the present disclosure. It should be understood that each block of the flow diagrams and/or block diagrams and a combination of the blocks can be implemented by computer-readable program instructions.

These computer-readable program instructions may be provided to a processor of a general-purpose computer, special-purpose computer, or other programmable apparatus to produce a machine, such that execution of the instructions by the processor creates a means for implementing functions specified in one or more blocks in the flow diagrams and/or block diagrams.

These computer-readable program instructions may also be stored in a computer-readable memory, and these instructions cause a computer to work in a specific manner, such that an article of manufacture is produced, including instructions for implementing functions specified in one or more blocks in the flow diagrams and/or block diagrams.

The present disclosure may take the form of an entire hardware embodiment, an entire software embodiment, or an embodiment combining software and hardware aspects.

With the path planning method and apparatus and the crane in the above embodiments, the driving path of the crane can be automatically planned, improving the flexibility and planning effect of the planning of the driving path of the crane.

So far, the path planning method and apparatus and the crane according to the present disclosure have been described in detail. Some details well known in the art have not been described in order to avoid obscuring the concepts of the present disclosure. Those skilled in the art can fully appreciate how to implement the technical solutions disclosed herein according to the foregoing description.

1. A path planning method, comprising:
obtaining an environmental image during a driving process of a vehicle;
processing the environmental image by using a trained target detection model to identify an obstacle in an environment where the vehicle is located;
in a case where an environmental point cloud corresponding to the environmental image is obtained and a system performance index meets a preset condition, determining a spatial position of the obstacle by using the environmental point cloud corresponding to the environmental image; and
adjusting an initial driving path of the vehicle according to a current position of the vehicle, the spatial position of the obstacle, and a target position of the vehicle.

2. The path planning method according to claim 1, further comprising:
in a case where the environmental point cloud corresponding to the environmental image is not obtained, or the system performance index does not meet the preset condition, determining the spatial position of the obstacle according to a transformation between a pixel coordinate and a spatial coordinate.

3. The path planning method according to claim 2, wherein the transformation between the pixel coordinate and the spatial coordinate is a transformation between the pixel coordinate and a spatial coordinate in a vehicle coordinate system, and the determining the spatial position of the obstacle according to a transformation between a pixel coordinate and a spatial coordinate comprises:
setting a plurality of pixel grids on the environmental image;
searching the plurality of pixel grids for a pixel grid where the obstacle is located;
determining a pixel coordinate of the obstacle according to the pixel grid where the obstacle is located; and
determining a spatial position of the obstacle in the vehicle coordinate system, according to the pixel coordinate of the obstacle and the transformation between the pixel coordinate and the spatial coordinate in the vehicle coordinate system.

4. The path planning method according to claim 3, wherein the setting a plurality of pixel grids on the environmental image, comprises:
processing the environmental image by using a trained road segmentation model, to identify a drivable road area for the vehicle; and
setting the plurality of grids on the drivable road area on the environmental image.

5. The path planning method according to claim 1, wherein the determining a spatial position of the obstacle by using the environmental point cloud corresponding to the environmental image comprises:
determining, from the environmental point cloud, a point cloud point matched with an image coordinate of the obstacle; and
determining a spatial position of the obstacle in a vehicle coordinate system, according to the point cloud point matched with the image coordinate of the obstacle and a coordinate transformation between a radar coordinate system where the point cloud point is located and the vehicle coordinate system.

6. The path planning method according to claim 1, wherein the adjusting an initial driving path of the vehicle according to a current position of the vehicle, the spatial position of the obstacle, and a target position of the vehicle comprises:
determining whether a distance from the vehicle to the obstacle is less than or equal to a safe distance; and
in a case where the distance from the vehicle to the obstacle is less than or equal to the safe distance, re-planning a driving path of the vehicle according to the current position of the vehicle, the spatial position of the obstacle, and the target position of the vehicle, and adjusting the initial driving path of the vehicle according to the re-planned driving path.

7. The path planning method according to claim 6, further comprising:
in a case where the distance from the vehicle to the obstacle is less than or equal to the safe distance, instructing the vehicle to stop; and
after the adjusted driving path of the vehicle is obtained, instructing the vehicle to resume driving and continue driving according to the adjusted driving path of the vehicle.

8. The path planning method according to claim 6, wherein the safe distance is in positive correlation with a size of the vehicle.

9. The path planning method according to claim 6, further comprising:
in a case where there is no obstacle in the environment where the vehicle is located, or the distance between the vehicle and the obstacle is greater than the safe distance, instructing the vehicle to continue driving according to the initial driving path.

10. The path planning method according to claim 1, further comprising:
before the obtaining an environmental image during a driving process of a vehicle, planning the initial driving path of the vehicle by using a preset path planning algorithm, according to a pre-constructed global environmental map, an initial position of the vehicle, and the target position of the vehicle; and/or
in a case where there is the obstacle in the environment where the vehicle is located, updating the pre-constructed global environmental map according to information of the obstacle.

11. (canceled)

12. A path planning apparatus, comprising:
a processor coupled to the memory, the processor being configured to perform, based on instructions stored in the memory, a path planning method comprising:
obtaining an environmental image during a driving process of a vehicle;
processing the environmental image by using a trained target detection model to identify an obstacle in an environment where the vehicle is located;
in a case where an environmental point cloud corresponding to the environmental image is obtained and a system performance index meets a preset condition, determining a spatial position of the obstacle by using the environmental point cloud corresponding to the environmental image; and
adjusting an initial driving path of the vehicle according to a current position of the vehicle, the spatial position of the obstacle, and a target position of the vehicle.

13. A crane, comprising:
the path planning apparatus according to claim 11.

14. A non-transitory computer-readable storage medium having thereon stored computer program instructions which, when executed by a processor, implement the a path planning method comprising:
obtaining an environmental image during a driving process of a vehicle;
processing the environmental image by using a trained target detection model to identify an obstacle in an environment where the vehicle is located;
in a case where an environmental point cloud corresponding to the environmental image is obtained and a system performance index meets a preset condition, determining a spatial position of the obstacle by using the environmental point cloud corresponding to the environmental image; and
adjusting an initial driving path of the vehicle according to a current position of the vehicle, the spatial position of the obstacle, and a target position of the vehicle.

15. (canceled)

16. The path planning apparatus according to claim 12, wherein the processor is further configured to perform:
in a case where the environmental point cloud corresponding to the environmental image is not obtained, or the system performance index does not meet the preset condition, determining the spatial position of the obstacle according to a transformation between a pixel coordinate and a spatial coordinate.

17. The path planning apparatus according to claim 16, wherein the transformation between the pixel coordinate and the spatial coordinate is a transformation between the pixel coordinate and a spatial coordinate in a vehicle coordinate system, and the determining the spatial position of the obstacle according to a transformation between a pixel coordinate and a spatial coordinate comprises:
setting a plurality of pixel grids on the environmental image;
searching the plurality of pixel grids for a pixel grid where the obstacle is located;
determining a pixel coordinate of the obstacle according to the pixel grid where the obstacle is located; and
determining a spatial position of the obstacle in the vehicle coordinate system, according to the pixel coordinate of the obstacle and the transformation between the pixel coordinate and the spatial coordinate in the vehicle coordinate system.

18. The path planning apparatus according to claim 17, wherein the setting a plurality of pixel grids on the environmental image, comprises:
processing the environmental image by using a trained road segmentation model, to identify a drivable road area for the vehicle; and
setting the plurality of grids on the drivable road area on the environmental image.

19. The path planning apparatus according to claim 12, wherein the determining a spatial position of the obstacle by using the environmental point cloud corresponding to the environmental image comprises:
determining, from the environmental point cloud, a point cloud point matched with an image coordinate of the obstacle; and
determining a spatial position of the obstacle in a vehicle coordinate system, according to the point cloud point matched with the image coordinate of the obstacle and a coordinate transformation between a radar coordinate system where the point cloud point is located and the vehicle coordinate system.

20. The path planning apparatus according to claim 12, wherein the adjusting an initial driving path of the vehicle according to a current position of the vehicle, the spatial position of the obstacle, and a target position of the vehicle comprises:
determining whether a distance from the vehicle to the obstacle is less than or equal to a safe distance; and
in a case where the distance from the vehicle to the obstacle is less than or equal to the safe distance, re-planning a driving path of the vehicle according to the current position of the vehicle, the spatial position of the obstacle, and the target position of the vehicle, and adjusting the initial driving path of the vehicle according to the re-planned driving path.

21. The path planning apparatus according to claim 20, wherein the processor is further configured to perform:
in a case where the distance from the vehicle to the obstacle is less than or equal to the safe distance, instructing the vehicle to stop; and
after the adjusted driving path of the vehicle is obtained, instructing the vehicle to resume driving and continue driving according to the adjusted driving path of the vehicle.

22. The path planning apparatus according to claim 20, wherein the safe distance is in positive correlation with a size of the vehicle.
